(19) United States
(12) Patent Application Publication
(10) Pub. No.: US 2006/0165093 A1
(43) Pub. Date: Jul. 27, 2006

(54) Method and apparatus to support multi-stack hang time usage and multi-stack accounting

(75) Inventors: Michael Borella, Naperville, IL (US); Ravideep Bhatia, West Dundee, IL (US); Chandra Warrier, Schaumburg, IL (US); Mankesh Ahluwalia, Hoffman Estates, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/044,951

(22) Filed: Jan. 27, 2005

(51) Int. Cl. H04L 12/56; H04L 12/28

(52) U.S. Cl. 370/395.52

(57) ABSTRACT

A network access element (100) having an ability (11) of support communication sessions for a multi-stack Internet Protocol device is further preferably provided with an ability (12) to use a hang time in conjunction with at least one of the communication sessions. In a preferred approach, a network access element having an ability to support communication sessions for a multi-stack Internet Protocol device is further provided with an ability to update (38) corresponding accounting information.

### TECHNICAL FIELD

This invention relates generally to Internet Protocol usage and support and more particularly to multi-stack Internet Protocol usage and support.

### BACKGROUND

Internet Protocol-based network communications are well know in the art and include, at present, both Internet Protocol version 4 and Internet Protocol version 6-based protocols. Some approaches (such as CDMA2000) permit and support the use of so-called dual-stack client devices having an ability to operate with either Internet Protocol version 4 and Internet Protocol version 6, individually (with singular or multiple usage) or simultaneously with one another. This typically means that the client device and a corresponding remote network access server (such as, but not limited to, a packet data serving node) are able to run at least two different network control protocols (such as Internet Protocol Control Protocol and Internet Protocol version 6 Control Protocol) over a single Point-to-Point Protocol session.

Such multi-stack support, however, gives rise to new problems. For example, accounting streams are typically based on Remote Authentication Dial-In User Service (RADIUS) messages and assume the existence of only one Network Control Protocol that is associated with a given Point-to-Point Protocol session. Multi-stack support, however, contemplates associating multiple Network Control Protocols (and/or multiple instances of a same Network Control Protocol) with a single Point-to-Point Protocol session. Present accounting protocols and practices, therefore, are unable to provide a desired data granularity with respect to actual network resource usage in all cases. This, in turn, can lead to lost revenue opportunities for a network operator and/or unfair billing practices for network users.

Another problem concerns the amount of network resources required to construct and/or to tear down, for example, the Link Control Protocol layer of a Point-to-Point Protocol session. With earlier configurations, lacking multi-stack support, resource wastage associated with tearing down such a layer at the conclusion of a communication session, only to momentarily rebuild an identical capability for that same user a moment later to support a continuation of that communication session has been largely tolerated. With multi-stack support, however, the likelihood that an apparent end of given communication session will be momentarily followed by, for example, a new communication session for that same client device using a different Network Control Protocol increases. This, in turn, increases the rate at which corresponding Point-to-Point Protocol layers are needlessly torn down and rebuilt, thereby inefficiently consuming network resources and potentially lowering system throughput capability and overall quality of service levels.

### BRIEF DESCRIPTION OF THE DRAWINGS

The above needs are at least partially met through provision of the method and apparatus to support multi-stack hang time usage and multi-stack accounting described in the following detailed description, particularly when studied in conjunction with the drawings, wherein:

FIG. 1 comprises a signal flow diagram as configured in accordance with prior art practice;

FIG. 2 comprises a flow diagram as configured in accordance with various embodiments of the invention;

FIG. 3 comprises a flow diagram as configured in accordance with various embodiments of the invention;

FIG. 4 comprises a signal flow diagram as configured in accordance with various embodiments of the invention;

FIG. 5 comprises a signal flow diagram as configured in accordance with various embodiments of the invention;

FIG. 6 comprises a flow diagram as configured in accordance with various embodiments of the invention;

FIG. 7 comprises a signal flow diagram as configured in accordance with various embodiments of the invention;

FIG. 8 comprises a signal flow diagram as configured in accordance with various embodiments of the invention;

FIG. 9 comprises a signal flow diagram as configured in accordance with various embodiments of the invention; and

FIG. 10 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a network access element (such as, but certainly not limited to, a packet data serving node) is provided with an ability to support communication sessions for a multi-stack Internet Protocol device (such as, but not limited to, a mobile station). Pursuant to a preferred but optional approach, that network access element is then also provided with an ability to use a hang time in conjunction with at least one of the communication sessions. Also pursuant to a preferred but optional approach, that network access element is also provided with an ability to differentiate between various network resources (such as, for example, Network Control Protocol layers of a Point-to-Point Protocol session) as are used to support various communication sessions that share at least one common network resource (such as, for example, a Link Control Protocol layer of a Point-to-Point Protocol session) to thereby facilitate discrete accounting recordations corresponding thereto.

The hang time capability permits the network access element to avoid needlessly tearing down a shared resource (such as a Link Control Protocol layer of a Point-to-Point Protocol session) as various discrete resources (such as different, or multiple instances of, Network Control Protocol sessions of a Point-to-Point Protocol session) are brought up and down in relatively quick succession by or on behalf of a given multi-stack Internet Protocol device. The improved accounting capability, used alone and/or in conjunction with a hang time capability, permits greater flexibility and accuracy with respect to tracking and/or billing with respect to the actual network usage of a given client device.

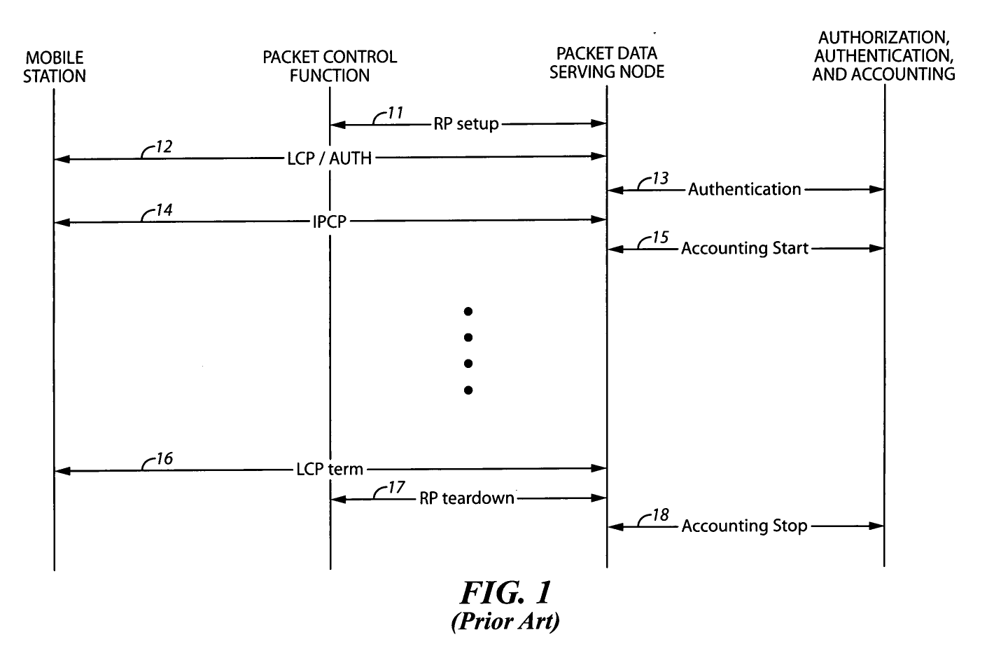

These and other benefits may become clearer upon making a thorough review and study of the following detailed description. Referring now to the drawings, and in particular to FIG. 1, it may be helpful to first briefly describe and characterize a relevant prior art approach using an illustrative specific example. Following Radio Protocol (RP) setup 11 as negotiated between a packet control function and a remote network access device such as a packet data serving node, a given mobile station then establishes a Point-to-Point Protocol session comprising a Link Control Protocol layer 12 with the packet data serving node and seeks network authorization.

The packet data serving node establishes corresponding authentication 13 with an authorization, authentication, and accounting element and then establishes an Internet Protocol Control Protocol (IPCP) session 14 with the mobile station to support, for example, a requested Internet Protocol version 4 session. With establishment of this IPCP session 14, the packet data serving node updates the authorization, authentication, and accounting element by providing an accounting start RADIUS message 15.

Eventually, the mobile station will conclude this communication session and termination 16 of the Link Control Protocol layer of the Point-to-Point Protocol session will follow. The packet control function and packet data serving node then tear down 17 the corresponding Radio Protocol session and the packet data serving node sends accounting stop information 18 to the authorization, authentication, and accounting element (those skilled in the art will know and recognize that, in some instances, the accounting stop may be instigated by the tearing down of the Point-to-Point Protocol session as versus the tear down of the Radio Protocol link). (Those skilled in the art will also known and recognize that other accounting start and stop message pairs may occur during the course of such a communication session based upon such triggers as the handoff of that call to a new packet control function, the dynamic changing of Usage Data Record (UDR) accounting attributes, the reception of active start or active stop Radio Protocol messages from a packet control function, the actions of an interim accounting timer and/or a time-of-day timer, and so forth.)

It can therefore be seen that the accounting information developed in this way corresponds, more or less, to actual network resource usage of the mobile station to support the described communication session. As noted above, however, this relatively straight-forward approach obscures much of relevance when applied in a multi-stack context and introduces other concerns and issues due to its single-minded reliance upon a one-to-one correspondence between a given type and duration of network usage with maintenance and existence of all layers of the Point-to-Point Protocol session itself.

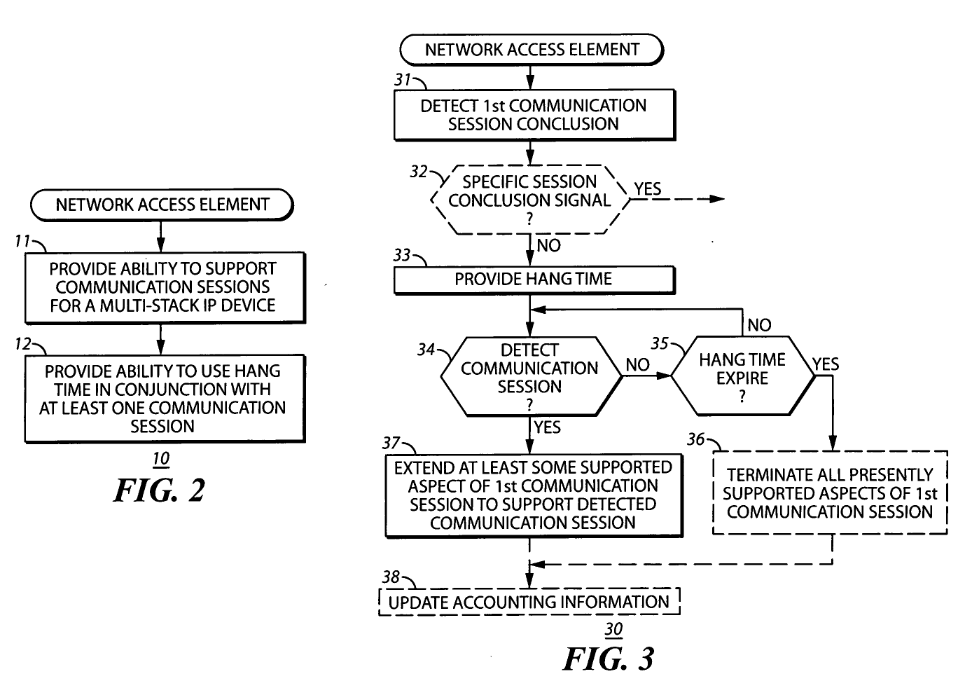

Referring now to FIG. 2, pursuant to one general approach 10, a network access element such as but not limited to a packet data serving node is provided 11 with an ability to support communication sessions for a multi-stack Internet Protocol device. This capability can comprise, for example, an ability to support both Internet Protocol version 4 communication sessions and Internet Protocol version 6 communication sessions (to thereby effect compatible support for a multi-stack Internet Protocol device (such as a mobile device) that can support individual and/or simultaneous use of such protocol versions). As per this approach 10, this network access element is further provided 12 with an ability to use a hang time in conjunction with at least one of the communication sessions.

Pursuant to one approach, this ability to use a hang time further comprises providing the network access element with an ability to use a selectively variable duration hang time (over a range, for example, of from about zero to about 15 seconds, though longer durations may be preferable for some applications). In general, and pursuant to a preferred approach, this ability to use a hang time further comprises an ability to maintain at least a lower level Point-to-Point Protocol session for the multi-stack Internet Protocol device during at least a portion, and preferably during all, of the hang time.

The above-described ability to use a hang time can be realized in any of a wide variety of ways. A preferred process 30 will now be described with reference to FIG. 3. Pursuant to this preferred approach 30, upon detecting 31 what may be the conclusion of a first communication session for the multi-stack Internet Protocol device, the network access element can optionally determine 32 whether a specific session conclusion signal (such as a Link Control Protocol termination signal as is known in the art) has been received (for example, from the multi-stack Internet Protocol device, a packet control function, an accounting server, or otherwise). If true, the network access element can effect, if desired, a prior art session closure process that may include, for example, a corresponding accounting stop update for the closed first communication session.

When the specific session conclusion signal has not been detected (or when this option has not otherwise been deployed), the network access element responds to the detection 31 of a likely termination of the first communication session by providing 33 a hang time. The duration of the hang time can be static or dynamic (automatically varying, for example, with respect to the nature of the first communication session itself, a profile as characterizes the mobile station itself, a day of the week and/or time of the day, and so forth). When static, the hang time duration may also be nevertheless changeable by, for example, an authorized network administrator.

To provide 33 this hang time window, the network access element preferably continues to maintain at least one network resource notwithstanding having released/torn down some portion of the first communication session. For example, the network access element may have torn down the Network Control Protocol layer of a Point-to-Point Protocol session as was used to facilitate the first communication session but will continue to maintain the Link Control Protocol layer of that Point-to-Point Protocol session.

The network access element then monitors to detect 34 whether a relevant communication session occurs for the multi-stack Internet Protocol device. A relevant communication session might be, for example, a continuation of the first communication session and/or a new communication session (possibly using, for example, a different Network Control Protocol or a same Network Control Protocol as the first communication session). While repeatedly monitoring in this regard, the network access element preferably continues checking to determine 35 if the hang time window has expired. If and when the hang time window expires without having detected a communication session of interest, the network access element can, for example, terminate 36 all presently supported aspects of the first communication session (thereby finally tearing down, for example, the Link Control Protocol layer of the Point-to-Point Protocol session).

When a communication session of interest is detected 34 during the hang time window, however, the network access device will preferably extend 37 at least some supported aspect of the first communication session to thereby provide support for the detected communication session. As one illustrative example, the network access device can continue to maintain the Link Control Protocol layer of the Point-to-Point Protocol session and to use that session in support of the detected communication session. In a preferred approach, this extension of support 37 will further comprise concluding the hang time monitoring and response window.

If desired, and as will be described in more detail below, the various actions taken above can also lead to an optional corresponding updating 38 of accounting information. For example, information regarding the duration of hang time during which the specific network resource was maintained can be locally logged and/or automatically forwarded to a remote accounting server such that an account as corresponds to the multi-stack Internet Protocol device can be debited with respect to hang time network resource usage notwithstanding the earlier release of at least some of the network resources. For example, if desired, one accounting charge may be made with respect to maintenance of the Link Control Protocol layer and a different accounting charge may be made with respect to the Network Control Protocol layer as was earlier terminated.

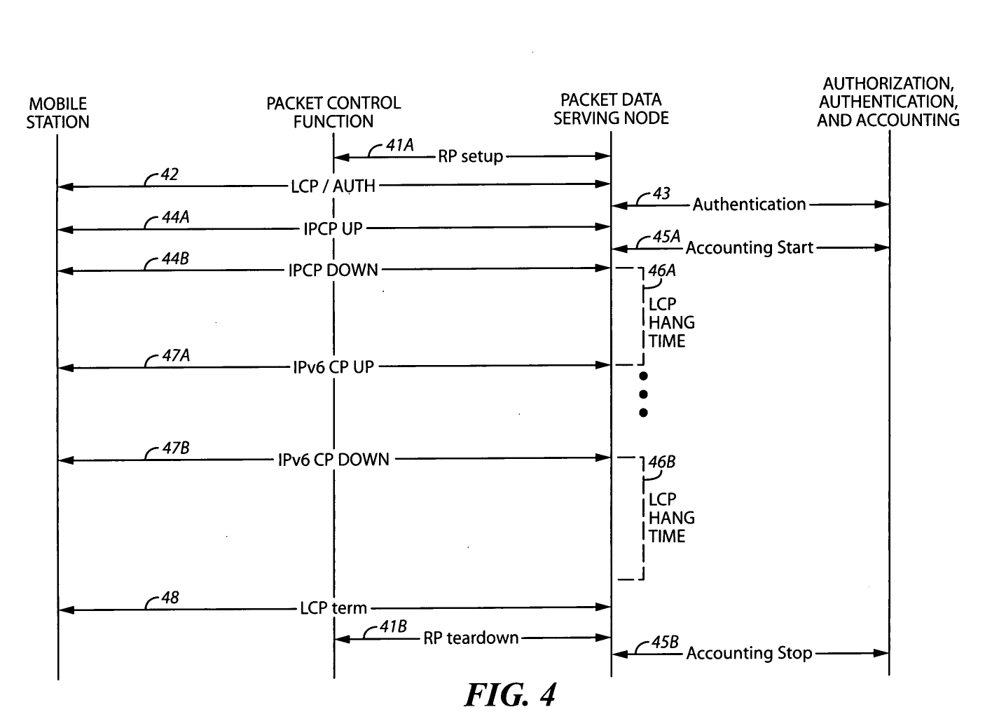

Referring now to FIG. 4, a specific illustrative example will be provided (those skilled in the art will readily recognize and appreciate that the specifics of this example and those that follow serve an illustrative purpose only and are not intended to circumscribe or otherwise limit the scope of the inventive concepts being set forth).

In this illustrative example, and following Radio Protocol setup 41A as between a packet control function and a packet data serving node, a multi-stack mobile station establishes the Link Control Protocol portion 42 of a Point-to-Point Protocol session with the packet data serving node and seeks authentication. The packet data serving node establishes authentication 43 with a corresponding authorization, authentication, and accounting element and then establishes a Network Control Protocol session with the mobile station (in particular, in this example, the Network Control Protocol session 44A comprises an Internet Protocol Control Protocol as characterizes, for example, Internet Protocol version 4). The packet data serving node then provides a RADIUS accounting start message 45A to the authorization, authentication, and accounting element.

Upon concluding its use of the Internet Protocol Control Protocol session, the mobile station/packet data serving node tear down 44B the Internet Protocol Control Protocol session. Notwithstanding this action, and pursuant to these teachings, the packet data serving node continues to maintain the Link Control Protocol layer of the corresponding Point-to-Point Protocol session and begins the above-described hang time window 46A. In this example, the mobile station/packet data serving node bring up a new communication session that makes use of an Internet Protocol version 6 Control Protocol session 47A prior to the conclusion of the hang time window. When this occurs, the packet data serving node terminates the hang time process and supports the new communication session using the original Link Control Protocol session.

When this second communication session eventually concludes, the mobile station/packet data serving node tear down 47B the Internet Protocol version 6 Control Protocol layer of the Point-to-Point Protocol session and the packet data serving node again initiates the hang time process 46B. This time, the mobile station does not seek to continue an earlier session nor initiate a new communication session during the full run of the hang time window 46B. At the conclusion of the hang time window 46B, the packet data serving node tears down 48 the Link Control Protocol layer of the Point-to-Point Protocol session and/or tears down 41B the Radio Protocol session.

So configured, the network is able to support a series of communication sessions without repeatedly needing to tear down/build up a supporting lower level Point-to-Point Protocol session. Depending upon network loading and individual mobile station usage, this can provide considerable savings with respect to overall network resource usage and allocation and/or can significantly reduce access time for the client device.

In the depicted example, the packet data serving node concludes by sending a RADIUS accounting stop 45B to the authorization, authentication, and accounting element. So configured, an account for the mobile station will simply reflect total time used by the mobile station when using a corresponding Network Control Protocol in addition to hang time spent supporting the lower level(s) of a facilitating Point-to-Point Protocol session. This may be adequate for some purposes. In many cases, however, this undetailed accounting information will be considered insufficient. It does not differentiate, for example, between the two kinds of Network Control Protocols being supported. This, in turn, renders it more difficult to differentiate billing rates and restrictions with respect to supporting different sessions.

It should be noted that, in the example provided, the multiple sessions do not overlap with one another. The problems noted, however, can further complicate the accounting issues when simultaneous sessions are supported. For example, if a given mobile station uses two simultaneous Network Control Protocol sessions in conjunction with a common Point-to-Point Protocol session, the mobile station may be able to effectively receive a two-for-the-price-of-one pricing allocation when only the start and end points of the overall Point-to-Point Protocol session are used to trigger the relevant accounting data points.

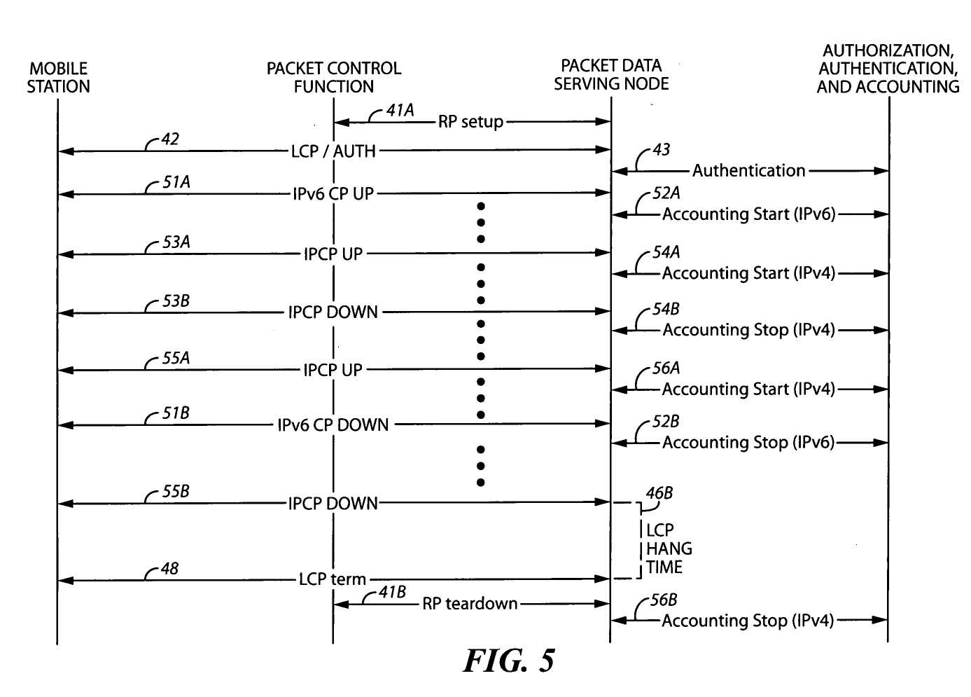

It may therefore be preferable, at least in some settings, to provide for accounting information prompts as correspond to bringing up and tearing down communication sessions as viewed from the standpoint of, for example, Network Control Protocol sessions rather than the Link Control Protocol layer of the corresponding Point-to-Point Protocol session and/or the Radio Protocol session(s). To illustrate, and referring now to FIG. 5, following initial establishment of the Link Control Protocol layer 42 of a Point-to-Point Protocol session, a given multi-stack mobile station establishes an Internet Protocol version 6 Control Protocol layer 51A with respect to that Point-to-Point Protocol session. The packet data serving node, in response, sends a RADIUS accounting start message 52A to a corresponding authorization, authentication, and accounting element.

Later, and prior to concluding that Internet Protocol version 6 Control Protocol-based session 51A, the mobile station establishes a second communication session simultaneous with that first session. In particular, in this example, the mobile station establishes an Internet Protocol Control Protocol layer 53A (again in conjunction with the original Point-to-Point Protocol session). At this point, and notwithstanding that the packet data serving node is already supporting a first communication session with that Point-to-Point Protocol session, the packet data serving node transmits another accounting start message 54A to the authorization, authentication, and accounting element. This accounting start message 54A, in this example, corresponds to and reflects initiation of the new communication session 53A and provides for resource usage and tracking that is somewhat removed from the lower layers of an enabling Point-to-Point Protocol session (this separation is not complete, as termination of the Link Control Protocol layer of the Point-to-Point Protocol session will also necessarily terminate the higher layer Network Control Protocol sessions as well and may therefore be used as an accounting stop trigger if desired).

At this point, the mobile station is simultaneously using two essentially separate communication sessions using, in this example, two separate Network Control Protocols that share a common lower layer of a shared Point-to-Point Protocol session. The packet data serving node, in turn, has taken actions to permit individual accounting record taking for each such communication session. Additional sessions could be similarly added and layered if desired, including sessions based upon the same, or different, Network Control Protocols with corresponding accounting recording keeping responses by the packet data serving node.

In this example, the mobile station now tears down the second communication session by tearing down the Internet Protocol Control Protocol layer 53B. Notwithstanding that the associated Link Control Protocol layer of the Point-to-Point Protocol session remains active, and notwithstanding that another communication session using its own Network Control Protocol also remains active, the packet data serving node, pursuant to these teachings, responds to the conclusion of the second communication session by sourcing a corresponding accounting stop message 54B. This action permits accounting information regarding the specific duration of the second communication session to be developed and/or maintained notwithstanding the continued presence of a fundamental part of that session (i.e., the Link Control Protocol layer of the Point-to-Point Protocol session).

In this example, the mobile station next rebuilds an Internet Protocol Control Protocol session 55A (this may comprise a continuation of the earlier second communication session or may comprise a new session). Again, as before, the packet data serving node responds by sourcing an accounting start message 56A that corresponds with initiation of the new communication session. At this point, then, there are again two separate communication sessions being simultaneously supported for this mobile station using a shared Point-to-Point Protocol session.

Eventually, the mobile station concludes the first communication session and tears down that Internet Protocol version 6 Control Protocol-based session 51B. As with the earlier terminated Network Control Protocol session, the packet data serving node again sends a corresponding accounting stop 52B to the authorization, authentication, and accounting element.

At a later time, the mobile station concludes its last active communication session and tears down the one existing Network Control Protocol session 55B. In this instance, there are no other extant Network Control Protocol sessions being supported for the mobile station. Accordingly, and again in conformance with a preferred approach set forth above, the packet data serving node initiates a corresponding hang time 46B. During this hang time 46B the packet data serving node monitors to detect whether the mobile station seeks to initiate a new or follow-on communication session. And also as set forth above, in such a case, the packet data serving node preferably does not yet send a corresponding accounting stop notwithstanding that the mobile station has torn down the Network Control Protocol session.

In this example, the mobile station does not initiate any new or renewed communication sessions, and the hang time 46B concludes in due course. When this occurs, the Link Control Protocol layer of the Point-to-Point Protocol session is torn down 48 and, in a typical approach, the Radio Protocol session is also terminated 41B. And, again in conformance with the teachings set forth above, the packet data serving node at this point now transmits a final accounting stop 56B to close the accounting record for the last communication session conducted on behalf of the mobile station.

So configured, it can be seen and appreciated that a network element can monitor a network communication session that is supported, at least in part, by a first network resource and a second network resource, wherein the second network resource relies at least in part upon the first network resource. Upon detecting that apparent use of the second network resource concludes notwithstanding continued persistence of the first network resource, the network element is able to close an accounting record for the network communication session based on detecting this apparent conclusion of use of the second network resource. This permits great flexibility with respect to monitoring network usage and/or billing for used services.

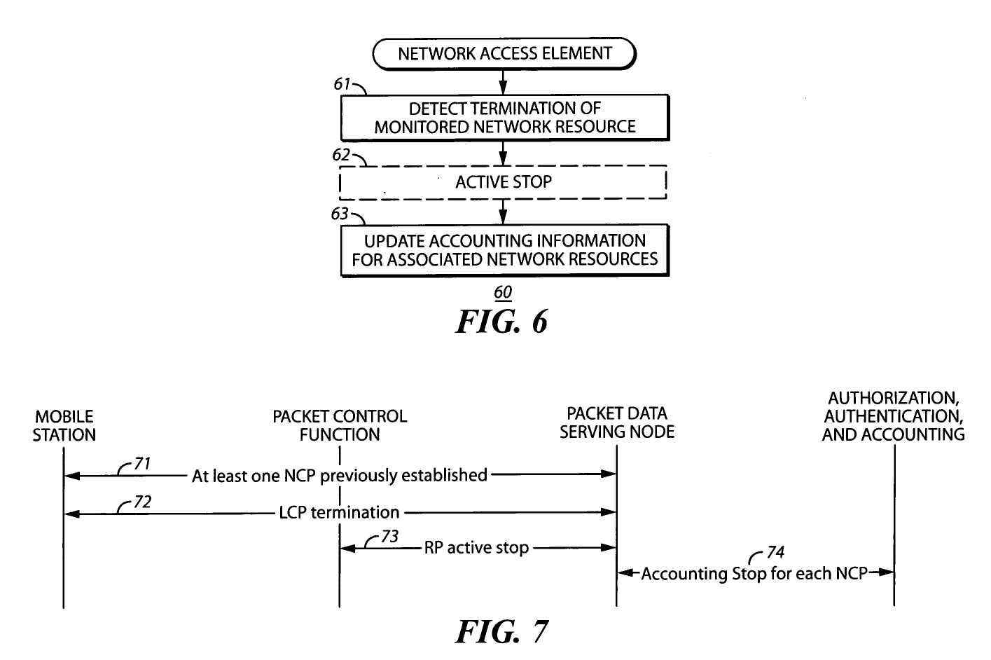

In the above examples, a higher layer protocol session concludes while a more fundamental layer protocol session continues. It is possible, however, for the more fundamental layer to terminate first. To accommodate such a situation, and referring now to FIG. 6, a network access element process 60 can further comprise detecting 61 the termination of a particular monitored network resource (such as, but not limited to, a Link Control Protocol layer of a Point-to-Point Protocol session) (which termination may be caused or initiated by, for example, the mobile station, the packet data serving node, or the like). Upon detecting termination of the monitored network resource (and optionally after also having detected an active stop 62), the network access element will preferably update 63 the accounting information for each associated network resource (such as, for example, each Network Control Protocol session as had been associated with the terminated Link Control Protocol session).

To illustrate, and referring now to FIG. 7, following establishment of at least one Network Control Protocol session 71, a packet data serving node participates in the termination of a corresponding Link Control Protocol session 72. In this illustrative example, the packet data serving node also waits for a Radio Protocol active stop 73 from the relevant packet control function and then effects an accounting stop 74 for each of the corresponding Network Control Protocol sessions as had been up at the time of terminating the Link Control Protocol session. So configured, the packet data serving node again aids in ensuring an accurate and complete accounting record for each supported Network Control Protocol session for a given mobile station.

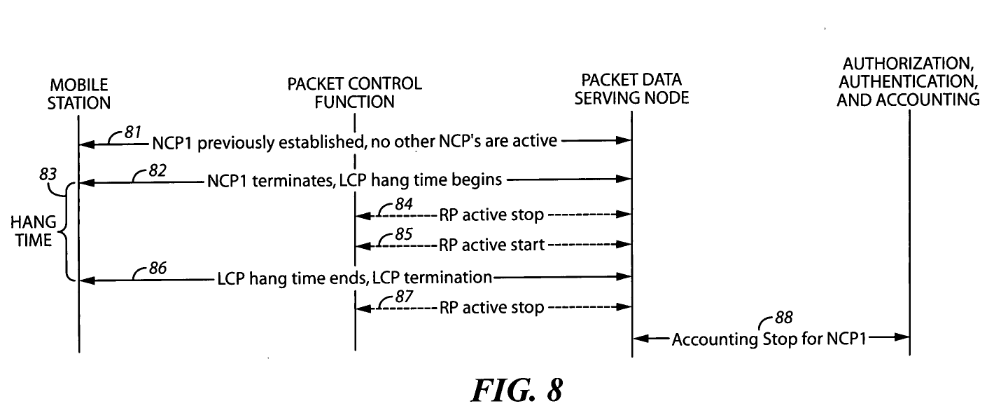

The teachings set for herein comprise, in the aggregate, a flexible and powerful tool set for network administrators and are able to accommodate a wide variety of operational scenarios. As one illustrative example, and referring now to FIG. 8, when only one Network Control Protocol session is active 81, and that session terminates 82, a corresponding packet data serving node can initiate a hang time 83. In this example, the hang time 83 concludes without another Network Control Protocol session becoming active and therefore the corresponding Link Control Protocol session is terminated 86. During the hang time 83, however, Radio Protocol active stops 84 and active starts 85 may have been received. By one approach, these intervening active stops and starts can be ignored from an accounting standpoint.

Instead, as illustrated, a final accounting stop 88 for the terminated Network Control Protocol session can be automatically sent by the packet data serving node following conclusion of the hang time 83 (and, in this embodiment, receipt of a final active stop 87 to pair with a last active start 85 that had been received during the hang time 83). In a preferred approach, the packet data serving node may use information from that final active stop 73 as well as other information of interest in the mobile station's UDR to form the substance of that accounting stop 74.

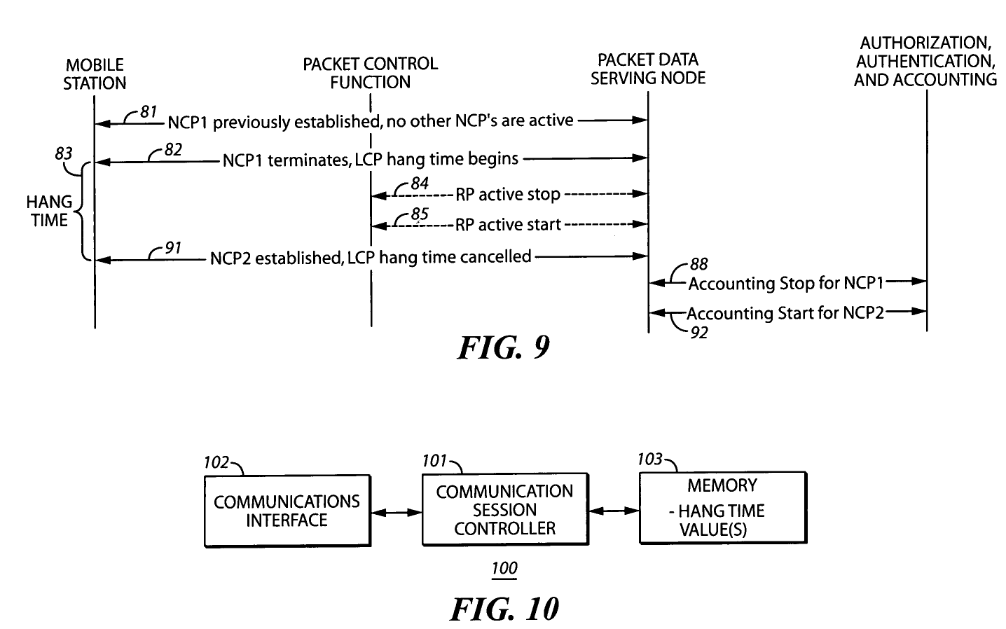

As another illustrative example, and referring now to FIG. 9, a session flow may proceed as described above until, in this example, a second Network Control Protocol session 91 becomes active during the hang time 83. In this case the packet data serving node cancels the hang time 83 and effects an accounting stop 88 for the first Network Control Protocol session 81 and an accounting start 92 for the second Network Control Protocol session 91. In a preferred approach, the packet data serving node may extrapolate UDR parameters in order to provide the substantive content of the accounting stop 88.

In general, a supporting network access element, such as a packet data serving node, will record the times at which Network Control Protocol sessions begin and are terminated, the times at which a most recent Radio Protocol active start was received, and the times at which a most recent active stop was received, as such information can comprise a useful part of, or can be used to extrapolate the content of, corresponding accounting start and stop messages.

These teachings are implementable using a variety of realization techniques. In general, a supporting network access element 100 (see FIG. 10), such as a packet data serving node, will comprise in relevant part a communication session controller 101 that operably couples to a communications interface 102 (to interface to the mobile station, the accounting server, and so forth) and a memory 103. In a preferred approach the memory 103 has at least one communication link hang time value stored therein, and the communication session controller 101 is configured and arranged to support a plurality of communication sessions for a multi-stack Internet Protocol device using any of a plurality of communication protocols comprising at least a first and a second communication protocol, wherein the first and second communication protocols each require the support of a more fundamental communication link.

In a preferred approach, the communication session controller 101 serves to use the communication link hang time value to delay tearing down the more fundamental communication link when the more fundamental communication link is no longer supporting a communication session for the multi-stack Internet Protocol mobile station using any of the plurality of communication protocols. The communication session controller 101 further preferably serves (alone or in conjunction with a hang time capability) to determine when to start and stop accounting records for the communication sessions as a function, at least in part, of starting and stopping use of various ones of the plurality of communication protocols notwithstanding continued persistence of the more fundamental communication link.

So configured, these teachings permit accounting information to be more readily and more accurately gathered and retained for a multi-stack network device such as a multi-stack Internet Protocol mobile station. These teachings are also employable to permit improved efficiency with respect to the use of at least some network resources.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a network access element with an ability to support communication sessions for a multi-stack Internet Protocol device;
providing the network access element with an ability to use a hang time in conjunction with at least one of the communication sessions.

2. The method of claim 1 wherein the network access element comprises a Packet Data Serving Node.

3. The method of claim 1 wherein the communications sessions comprise at least either of an Internet Protocol version 4 communication session and an Internet Protocol version 6 communication session.

4. The method of claim 1 wherein the multi-stack Internet Protocol device comprises an Internet Protocol version 4 and Internet Protocol version 6 compatible device.

5. The method of claim 1 wherein the multi-stack Internet Protocol device comprises a mobile station.

6. The method of claim 1 wherein providing the network access element with an ability to use a hang time further comprises providing the network access element with an ability to use a selectively variable duration hang time.

7. The method of claim 1 and further comprising:
detecting what may be a conclusion of a first communication session for the multi-stack Internet Protocol device and, in response thereto, providing a hang time.

8. The method of claim 7 and further comprising:
monitoring to detect at least one of a continued first communication session and a new communication session to provide a detected communication session for the multi-stack Internet Protocol device during the hang time;
in response to detecting at least one of a continued first communication session and a new communication session for the multi-stack Internet Protocol device during the hang time extending at least some supported aspect of the first communication session to thereby provide support for the detected communication session.

9. The method of claim 8 and further comprising:
in response to not detecting at least one of a continued first communication session and a new communication session for the multi-stack Internet Protocol device during the hang time terminating all presently supported aspects of the first communication session.

10. The method of claim 7 wherein detecting what may be a conclusion of a first communication session for the multi-stack Internet Protocol device and, in response thereto, providing a hang time further comprises detecting a specific session conclusion signal from the multi-stack Internet Protocol device and, in response thereto, not providing the hang time.

11. The method of claim 10 wherein the specific session conclusion signal comprises a Link Control Protocol termination signal.

12. The method of claim 1 wherein providing the network access element with an ability to use a hang time in conjunction with at least one of the communication sessions further comprises maintaining at least a lower level Point-to-Point Protocol session for the multi-stack Internet Protocol device during the hang time.

13. The method of claim 1 and further comprising:
supporting a first communication session for the multi-stack Internet Protocol mobile station using at least two network resources;
upon detecting what may be a conclusion of the first communication session:
releasing at least one network resource to provide at least one released network resource;
maintaining at least one network resource to provide at least one maintained network resource;
initiating a hang time;
when a communication session becomes active for the multi-stack Internet Protocol mobile station during the hang time:
using the at least one maintained network resource to support the communication session;
using another network resource as an assigned network resource to support the communication session.

14. The method of claim 13 wherein the at least one released network resource and the assigned network resource each comprise a Network Control Program communication session layer and the at least one maintained network resource comprises a Link Control Protocol communication session layer.

15. The method of claim 13 and further comprising:
automatically providing accounting information as relates to the at least one maintained network resource.

16. The method of claim 15 wherein the accounting information comprises, at least in part, information regarding a duration of hang time during which the at least one network resource is maintained such that an account as corresponds to the multi-stack Internet Protocol mobile station can be debited with respect to hang time network resource usage notwithstanding release of at least some of the network resources.

17. The method of claim 15 wherein automatically providing accounting information further comprises maintaining a local store of the accounting information.

18. The method of claim 15 wherein automatically providing accounting information further comprises automatically forwarding at least some of the accounting information to a remote accounting server.

19. The method of claim 15 wherein the accounting information is associated with maintained network resource comprising a given one Network Control Protocol.

20. A method comprising:
monitoring a network communication session supported, at least in part, by a first network resource and a second network resource, wherein the second network resource relies at least in part upon the first network resource;
detecting when apparent use of the second network resource concludes notwithstanding continued persistence of the first network resource;
closing an accounting record for the network communication session based on detecting apparent conclusion of use of the second network resource notwithstanding continued persistence of the first network resource.

21. The method of claim 20 wherein the first network resource comprises a first layer of a Point-to-Point Protocol session and the second network resource comprises a second layer of a Point-to-Point Protocol session.

22. The method of claim 21 wherein the first network resource comprises a Link Control Protocol session and the second network resource comprises a Network Control Protocol session.

23. The method of claim 20 and further comprising:
while monitoring the network communication session, detecting a second network communication session supported, at least in part, by the first network resource and a third network resource, wherein the third network resource is different from the second network resource.

24. The method of claim 23 wherein the second network resource comprises a first Network Control Protocol and the third network resource comprises a second Network Control Protocol that is different from the first Network Control Protocol.

25. The method of claim 24 wherein the first Network Control Protocol comprises Internet Protocol Control Protocol and the second Network Control Protocol comprises Internet Protocol version 6 Control Protocol.

26. The method of claim 23 and further comprising:
starting an accounting record for the second network communication session based on detecting use of the third network resource.

27. The method of claim 26 and further comprising:
closing the accounting record for the second network communication session based on detecting apparent conclusion of use of the third network resource notwithstanding continued persistence of either of the first network resource and the second network resource.

28. The method of claim 20 wherein closing an accounting record for the network communication session based on detecting apparent conclusion of use of the second network resource notwithstanding continued persistence of the first network resource further comprises determining whether any other network communication session presently relies on the first network resource.

29. The method of claim 28 wherein closing an accounting record for the network communication session further comprises initiating a hang time window upon determining that no other network communication session presently relies on the first network resource.

30. The method of claim 29 wherein closing an accounting record for the network communication session further comprises not closing the accounting record for the network communication session until the hang time window concludes.

31. The method of claim 29 wherein not closing the accounting record for the network communication session until the hang time window concludes further comprises closing the accounting record for the network communication system prior to conclusion of the hang time window when a new network communication session begins that relies on the first communication resource during the hang time window.

32. An apparatus comprising:
a communications interface;
a communication session controller operably coupled to the communications interface and configured and arranged to support a plurality of communication sessions for a multi-stack Internet Protocol device using any of a plurality of communication protocols comprising at least a first and second communication protocol, wherein the first and second communication protocol require support of a more fundamental communication link;
a memory operably coupled to the communication session controller and having a more fundamental communication link hang time value stored therein.

33. The apparatus of claim 32 wherein the communication system controller further comprises means for using the more fundamental communication link hang time value to delay tearing down the more fundamental communication link when the more fundamental communication link is no longer supporting a communication session for the multi-stack Internet Protocol mobile station using any of the plurality of communication protocols.

34. The apparatus of claim 33 wherein the communication session controller further comprises accounting means for determining when to start and stop accounting records for the communication sessions as a function, at least in part, of starting and stopping use of various ones of the plurality of communication protocols notwithstanding continued persistence of the more fundamental communication link.

35. The apparatus of claim 32 wherein the communication session controller further comprises accounting means for determining when to start and stop accounting records for the communication sessions as a function, at least in part, of starting and stopping use of various ones of the plurality of communication protocols notwithstanding continued persistence of the more fundamental communication link.
